(19) United States
(12) Patent Application Publication
(10) Pub. No.: US 2012/0198490 A1
(43) Pub. Date: Aug. 2, 2012

(54) METHOD AND APPARATUS FOR SELECTIVELY RENDERING A CONTENT ITEM

(75) Inventor: Mark Jozef Willem Mertens, Eindhoven (NL)

(73) Assignee: KONINKLIJKE PHILIPS ELECTRONICS N.V., EINDHOVEN (NL)

(21) Appl. No.: 13/499,914

(22) PCT Filed: Sep. 27, 2010
(86) PCT No.: PCT/IB10/54338

§ 371 Date: Apr. 3, 2012

(30) Foreign Application Priority Data
Oct. 5, 2009 (EP) 09172197.7

(51) Int. Cl. H04N 21/23; H04N 21/43

(52) U.S. Cl. 725/24

(57) ABSTRACT

A content item comprising a plurality of segments is selectively rendered by selecting at least one segment of a content item having objectionable content, step (205); issuing an alert prior to rendering said selected at least one segment, step (207); and rendering said selected at least one segment if a user does not indicate an objection against having said selected at least one segment rendered, step (213).

### FIELD OF THE INVENTION

The present invention relates to method and apparatus for selectively rendering a content item. In particular, but not exclusively, it relates to a warning of objectionable content within a content item.

### BACKGROUND OF THE INVENTION

Extensive information has been made available worldwide. Some of the information is broadcast, offering a wide range of content. Some of the content may be considered offensive and inappropriate for the audience.

Many techniques have been developed to filter such objectionable material. For example, use of child locks, blocking access to certain broadcast channels or internet sites. However, such systems are invariably cumbersome as permissions must be given to view them, and it is difficult to more finely make choices, for example, a user may wish to see program having a medical theme but not those containing graphic scenes during operations.

Therefore, many known systems focus on removing objectionable material (it is not supposed to be seen by e.g. the child, usually on a fixed number of class codes, and/or fixed for an entire video segment). However, there is no provision for the user to have some control in the event that they wish to view it.

An alternative system is disclosed by U.S. Pat. No. 7,540,009 in which a tagging system is used in television program broadcast in which user defined icons are displayed as a warning of objectionable programming such that the tagged program can be skipped or altered. This system requires extensive user input to define objectionable content and define how it is to be handled/displayed. This requires extensive set up, is complex and provides little flexibility to changing how the objectionable content is to be handled/displayed. Furthermore, the interruptions caused by this system can be disruptive, reducing viewing pleasure.

### SUMMARY OF THE INVENTION

Therefore, it would be desirable to provide a simple and effective system for handling objectionable content, providing the user with individual control and flexibility whilst minimizing disruptions to viewing. The invention is defined by the independent claims. Advantageous embodiments are defined in the dependent claims.

This is achieved according to a first aspect of the present invention by a method for selectively rendering a content item, the content item comprising a plurality of segments, the method comprising the steps of: selecting at least one segment of a content item having objectionable content; issuing an alert prior to rendering the selected at least one segment; rendering the selected at least one segment if a user does not indicate an objection against having said selected at least one segment rendered.

This is also achieved according to a second aspect by apparatus for selectively rendering a content item, the content item comprising a plurality of segments, the apparatus comprising: an analyzer for selecting at least one segment of a content item having objectionable content; a controller for issuing an alert prior to rendering the selected at least one segment, and for enabling render of the selected at least one segment if a user does not indicate an objection against having said selected at least one segment rendered.

In an embodiment, rendering said selected at least one segment comprises rendering said at least one segment if no predetermined user input is received, e.g. within a predetermined time interval after issue of the alert. In a different embodiment or in the same embodiment, rendering said selected at least one segment comprises or further comprises rendering said at least one segment if a user indicates a desire to have said selected at least one segment rendered.

In this way, the content item will be rendered unless the user wishes otherwise. This minimizes the disruption caused whilst enabling content which is objectionable to be avoided. The content item may be a plurality of programs and each segment corresponding to each program or alternatively, the content item may be a particular program or programs and each segment corresponds to a portion of the program(s) such as a single picture, or a series of consecutive images forming a scene or a portion of audio, or a part of a text which fits on a page or in a sub window, whereby the next page or sub window may contain some objectionable paragraph, etc.

In an embodiment, issuing an alert may comprise at least one of: masking, for example, blurring visual and/or audio content of the content item; freezing render of the content item; issuing a visual and/or audio warning such as a displaying a text message issuing verbal message or bleep or the like; animating visual content of the content item. The alert may be issued prior to rendering the selected at least one segment upon selection of a channel rendering the at least one segment.

The alert warns/prepares the user, typically with a visual effect, such as “freeze frame” or blurred picture so that the user can decide whether to change channels or skip the objectionable content as desired. This can be particularly useful, when in zapping mode, i.e. when the user is skipping through many channels. The nature of the alert will enable the user to skip the channel quickly before viewing any objectionable material.

Whether content is considered objectionable may vary depending on the time of day. Therefore, objectionable content may be time sensitive and varying depending on the time of day or alternatively, the user may input that the current moment is inappropriate by providing an input upon which the objectionable content is not rendered. Further the objectionable content may be defined by the user based upon their preferences. This may be in the form of selectable modes of operation such as “easy-unobtrusive-content-only” mode which avoids objectionable language or long tedious debates, for example.

In an embodiment, the segments having objectionable content may be selected by extracting at least one feature of each segment of the content item; analyzing the extracted at least one feature as to whether the extracted at least one feature is objectionable; and selecting segments if the extracted at least one feature of the segment is objectionable. The extracted features may include meta data (such genre or indication of content or even degrees of classification of objectionable content e.g. “hardly-any-violence” up to “very-violent”), extracted visual features such as particular visual items (such as faces), color (such as red for blood) etc and/or extracted audio features (such as spoken words, pace and volume of music, explosions, screams etc). Any combination of these features may be used.

These and other aspects of the invention will be apparent from and elucidated with reference to the embodiments described hereinafter.

### BRIEF DESCRIPTION OF DRAWINGS

For a more complete understanding of the present invention, reference is now made to the following description taken in conjunction with the accompanying drawings in which:

FIG. 1 is a simplified schematic of an apparatus according to an embodiment of the present invention; and

FIG. 2 is a flowchart of the method steps according to an embodiment of the present invention.

### DETAILED DESCRIPTION OF EMBODIMENTS OF THE INVENTION

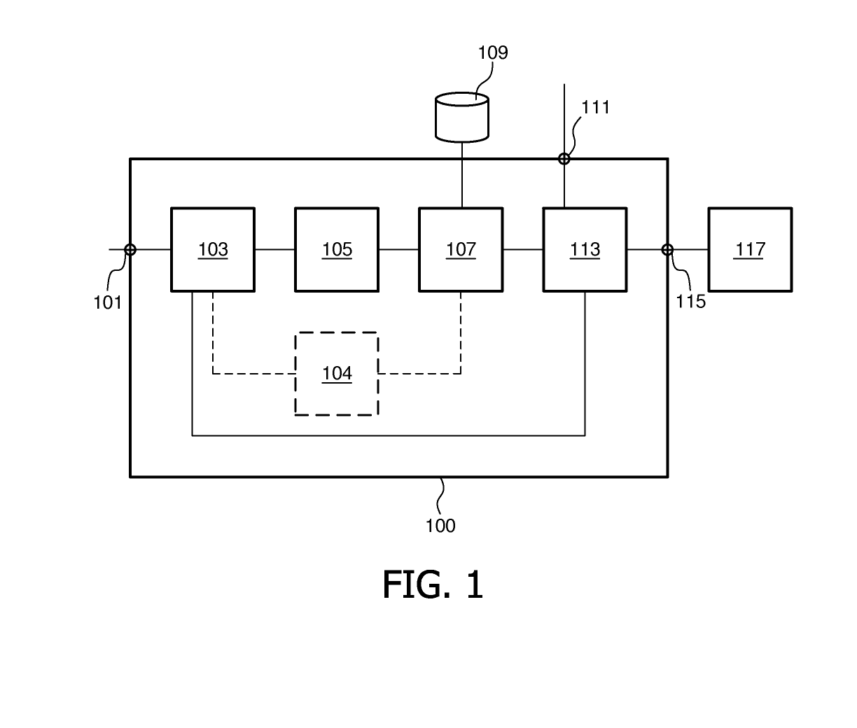

The apparatus of the embodiment may be an integral part of a television or a set top box or part of a computer system or game console for example. With reference to FIG. 1, the apparatus 100 of an embodiment of the present invention comprises a first input terminal 101. The first input terminal 101 is connected to a receiver 103. The receiver 103 comprises any generic receiver unit for receiving content such as audio and/or visual content. It may comprise a receiver for receiving content item broadcast over a plurality of channels such as television programming or a connection to an internet content database/library; or a decoding connection to a data storage such as a hard disk. The receiver 103 may be an integral part of the apparatus 100 or may be external and connected to the first input terminal of the apparatus 100. The output of the receiver 103 is connected to an extractor 105. The output of the extractor 105 is connected to an analyzer 107. The analyzer 107 is connected to a storage device 109.

Although the storage device 109 is illustrated here as external to the apparatus 100, in an alternative embodiment, the storage device 109 may be integral with the apparatus. The storage device 109 may be a memory device of a computer system, such as a ROM/RAM drive, CD, connected to the apparatus 100, or remote server. It may be accessed via a wired or wireless connection and/or accessed via a wider network such as the Internet. The storage device 109 stores a plurality of predefined objectionable features. If the predefined objectionable features are stored on a remote server, for example, they may be uploaded and temporarily stored in a local storage means (not shown here) of the apparatus 100. The storage device 109 may be a personal storage device, such as a memory stick containing user preferences which may be plugged into the apparatus, or an RFID card which may be laid on top of the apparatus. Thereby the apparatus either reads the preferences directly from that personal storage device, or reads a person identifier from the storage device specifying which subset of preferences to take from the built-in or connected storage means 109. Furthermore, the apparatus may be in a master-slave configuration, wherein the preferences are updated from an external device (e.g. a parent re-specifying the television permissions of the children after 18.00 hours).

The output of the analyzer 107 is connected to a controller 113. The controller is also connected to a second input terminal 111 for user input. The second input terminal 111 may be connected to a keyboard, keypad or remote control device. The controller 113 is also connected to the receiver 103. The output of the controller 113 is connected to an output terminal 115 of the apparatus 100. The output terminal 115 is connected to a rendering device 117 such as a display screen, loud speakers, television or the like.

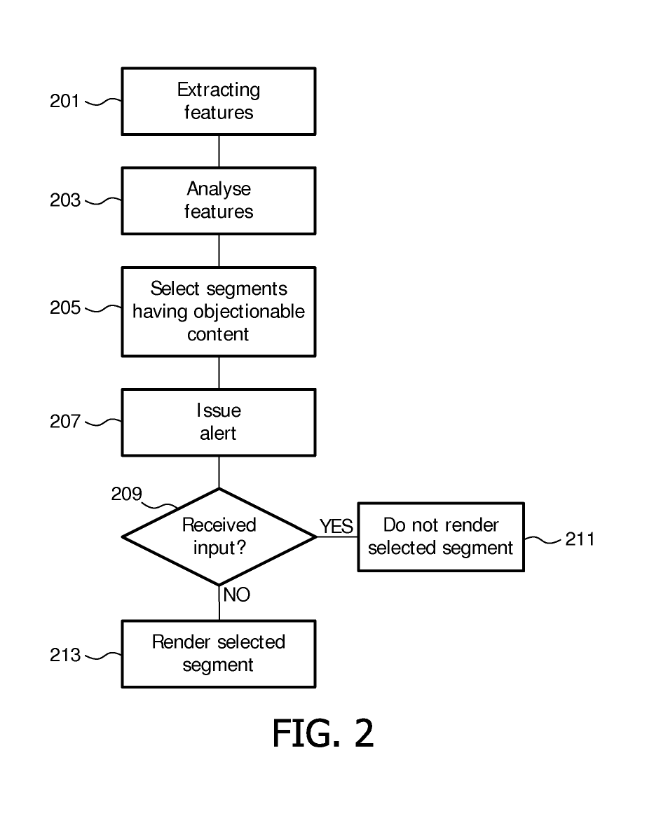

Operation of the apparatus 100 will now be described in more detail with reference to FIG. 2. A content item is broadcast or transmitted and received by the receiver 103 via the first input terminal 101 of the apparatus 100. The content item comprises a plurality of segments. The content item may be a plurality of programs and each segment corresponding to each program or alternatively, the content item may be a particular program or programs and each segment corresponds to a portion of the program(s) such as a frame, scene etc.

The content item is passed to the extractor 105 for extracting features such as meta data (such as genre), visual features such as particular visual items (such as faces), color (such as red for blood) etc and/or to extract audio features (such as spoken words, pace and volume of music, explosions, screams etc), step 201. The extraction of features may be sampled. The extractor 105 outputs descriptions of the content in terms of presence of features, and quantifications of those features (for example not just that a person is present but that person is aggressive or rude).

The output descriptions of the extractor 105 are analyzed by the analyzer 107, step 203 as to whether the extracted features are objectionable. For example, the analyzer 107 analyzes the extracted features as to whether they would be considered objectionable and to what degree and determine when (e.g. from which picture number or presentation time) the user should be alerted of the objectionable content so that, taking into account the user's preferences, the user sees, hear or reads enough to obtain an understanding of the nature of the objectionable content without having to view it. The user may define rules of severity which is incorporated into the analyzer 107. The algorithms for how to analyze the content, detect the presence and severity of these features and the type of alerting required etc is stored on the storage device 109.

The analyzer 107 outputs data to the controller 113 which receives the input content from the receiver 103 and according to the data output by the analyzer 107 controls rendering of the content item, step 207. For example, the controller 103 adapts the content item at a designated picture number or audio frame number to mask the display or at least part of the display or at least part of the display of the contents for example a certain degree of blurring so that the user can view the nature of the objectionable content without viewing the detail, or other visual or audible warning (this may additionally include information of the nature of the objectionable content); freezing the current frame being displayed; blocking part of the display; distortion of the audio; or animation of the content.

The controller 113 awaits an input command from the user via the second input terminal 111, step 209. This may be configured to await an input for a predetermined amount of time, step 209. If no input is received, the objectionable content is displayed, step 213 and the content item is rendering uninterrupted. The input may be based on a predetermined type of input such as changing channels, closing a viewing window etc, skip objectionable content etc. If the user inputs an command to change channels, skip the selected segment, the controller actions the command and the selected segment is not rendered, step 211. The user may be in zapping mode and rapidly changing channels. To avoid objectionable content being rendered as the channel is selected, the next channel content is sampled and feature extracted according to the method above. If objectionable content is detected prior to the content of that channel being rendered i.e. upon the channel being selected, the alert is issued and objectionable content avoided if required.

In a second embodiment, a metadata analyzer 104 may be incorporated as shown by dashed lines in FIG. 1. The metadata extractor 104 is connected between the receiver 103 and the analyzer 107 in parallel with the extractor 105. The metadata extractor 104 extracts meta information, such as, for example data in any video standard (for example supplemental enhancement information) metadata (for example EPG data) etc. The metadata extractor 104 outputs the metadata information to the analyzer 107 where it is analyzed as to whether it indicates objectionable content. In the simplest system this may be no more than encoding a time stamp, which will make the alerting means 113 freeze the desirable picture just before, or mask the undesirable picture just after (preferably with an indication in the content signal whether the previous or next picture should be shown), irrespective of what the actual content or reason for undesirability is. In case of a horrible monster face showing e.g., the alerting means will show a blurry monster face (still somewhat recognizable but not so scary), or a softened scary sound (so that it doesn't scare the listener as much), and then allow the entire blockage of what that monster is doing. But the same technology running on an erotic scene will freeze at a moment for example prior to nudity. To suit several kind of viewers, the apparatus may include further information in the content, describing what actually is happening, e.g. severity classes, or verbal descriptions to replace the actual rendering of the images. The content may also contain data prescribing which alerting operation to apply, for example, two sizes of blur kernel width. A cautious adult viewer may then see some of the objectionable content less clearly, whereas when the system is configured to operate with a minor, that minor will see a big blur with hardly anything recognizable in it. The analyzer 107 can detect the optimal time instant, and can optionally also detect which alerting to perform, based on complex analysis of all available feature data from feature extractor 105 and/or metadata analyzer 104. Furthermore, several time instants and alerting operations may be determined, which may be advantageous for systems sending the content to storage and systems in which objectionable content may be further explored to check its severity, with increasing severity demanding several different alerts, etc.

With a second tuner, sample channel characteristics may be sampled, and programs automatically rated, e.g. by doing analysis of snippets of the currently running content (typically periodically the second tuner would sample a couple of seconds of the channel, and then go to the next, etc., or it may only sample the next and previous channels, since those will be selected with the next or previous program zapping button). Alternatively metadata can be read from teletext lines, or any other program related data as explained above.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

As will be apparent to a person skilled in the art, the elements listed in the apparatus claims are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A method for selectively rendering a content item, the content item comprising a plurality of segments, the method comprising the steps of:
selecting (205) at least one segment of a content item having objectionable content;
issuing (207) an alert prior to rendering said selected at least one segment;
rendering (213) said selected at least one segment if a user does not indicate an objection against having said selected at least one segment rendered.

2. A method according to claim 1, wherein the step of rendering (213) said selected at least one segment comprises rendering said at least one segment if no predetermined user input is received.

3. A method according to claim 2, wherein the step of rendering (213) said selected at least one segment comprises rendering said selected at least one segment if no predetermined user input is received within a predetermined time interval after issue of the alert.

4. A method according to claim 1, wherein the step of rendering (213) said selected at least one segment comprises rendering said at least one segment if a user indicates a desire to have said selected at least one segment rendered.

5. A method according to claim 1, wherein the step of issuing (207) an alert comprises at least one of: blurring visual and/or audio content of said content item, freezing render of said content item, issuing a visual and/or audio warning, animating visual content of said content item and changing audio characteristics.

6. A method according to claim 1, wherein the step of selecting segments having objectionable content comprising the step of:
determining objectionable content based upon the time of day.

7. A method according to claim 1, wherein the step of selecting segments having objectionable content comprising the step of:
determining objectionable content based upon user preferences.

8. A method according to claim 1, wherein a plurality of content items is rendered over a plurality of channels, the step of issuing an alert comprises the step of:
issuing an alert prior to rendering said selected at least one segment upon selection of a channel rendering said at least one segment.

9. computer program product comprising a plurality of program code portions for enabling a programmable device to carry out the method according to claim 1.

10. Apparatus (100) for selectively rendering a content item, the content item comprising a plurality of segments, the apparatus (100) comprising:
an analyzer (107) for selecting at least one segment of a content item having objectionable content; and
a controller (113) arranged to issue an alert prior to rendering said selected at least one segment and enable render of said selected at least one segment if a user does not indicate an objection against having said selected at least one segment rendered.

11. Apparatus according to claim 10, wherein the apparatus further comprises:
an extractor (105) for extracting at least one feature of each segment of the content item; and
the analyzer (107) is arranged to analyze said extracted at least one feature as to whether the extracted at least one feature is objectionable and select segments having at least one objectionable feature.

12. Apparatus according to claim 11, wherein the apparatus further comprises:
a storage device (109) for storing a plurality of predefined objectionable features.
